(19) United States
(12) Patent Application Publication
(10) Pub. No.: US 2004/0019537 A1
(43) Pub. Date: Jan. 29, 2004

(54) Stock-warning system and method

(76) Inventors: Sheng Chi Luo, Tu-Chen (TW); Wei Zhang, Shenzhen (CN); Qiong-Shuai Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/330,587

(22) Filed: Dec. 27, 2002

(30) Foreign Application Priority Data
Jul. 26, 2002 (TW) 91116675

(51) Int. Cl. G06F 17/60

(52) U.S. Cl. 705/28

(57) ABSTRACT

A stock-warning system includes an order processor (3), a database server (1) including a database (10), and a programmable apparatus (2). The order processor receives forecasted requirements from customers and stores them in the database. The programmable apparatus includes an order-parsing module (22), a stock analysis module (24), a warning module (26), and a mail service module (28). The order-parsing module calculates requirements of each material based on the forecasted requirements. The stock analysis module calculates a maximum stock and a minimum stock of each material based on the calculated requirements of the material and on standard stock rules, determines whether a current stock of the material falls between the maximum stock and the minimum stock, and thereby creates a stock analysis result. The warning module creates warnings based on stock analysis results. The mail service module sends e-mail warnings to relevant users.

### FIELD OF THE INVENTION

This invention is related to systems and methods for controlling inventory, and especially to stock-warning systems and methods based on forecasted requirements from customers.

### BACKGROUND OF THE INVENTION

Efficient inventory control is a critical ingredient in the success or failure of many businesses. These businesses typically deal with complex inventory control tasks. Means for efficient inventory control have developed over a long period of time, and many techniques and methods have been devised. A typical technique is Reorder Point (ROP), in which a fixed quantity of goods are ordered when a stock level falls below a fixed value. Another technique is Lot Sizing Rule, including Lot for Lot, Least Total Cost, Periodic Review System, Periodic Order Quantity and Fixed Order Quantity. Certain techniques and methods are disclosed in patents. One example is U.S. Pat. No. 6,021,396 entitled Method to Provide Sensitivity Information for (R,s,S) Inventory Systems with Back-Ordered Demand. The patent discloses a system to provide sensitivity information about the average back-ordered sales and inventory levels of a back-order (R,s,S) inventory system with respect to the two decision variables s and S.

As economic environments become more complex, customers' requirements can become more variable. To completely fulfill customers' requirements while holding a relatively small level of stock, conventional techniques and methods are gradually become more limited in efficacy. One difficulty is that conventional techniques and methods does not adequately take into account variations in customers' requirements. Another difficulty is that conventional techniques and methods cannot adequately provide warning information to relevant inventory controllers. As a result, the inventory controllers cannot control inventory in a timely manner.

Accordingly, it is desired to provide a system and method which overcomes the abovementioned problems and difficulties.

### SUMMARY OF THE INVENTION

A primary object of the present invention is to provide a stock-warning system and method which receives forcasted requirements from customers and calculates standard stock according to the forcasted requirements.

Another object of the present invention is to provide a stock-warning system and method which creates warnings by determining whether current stock exceeds standard stock, and which sends warnings to relevant users so that the relevant users can timely control stock.

In one aspect of the present invention, a stock-warning system comprises: an order processor for receiving and processing forecasted requirements from one or more customers; a database server for receiving and accessing the forecasted requirements, the database server comprising a database for storing the forecasted requirements, e-mail addresses and bills of materials; and a programmable apparatus. The programmable apparatus comprises an order-parsing module, a stock analysis module, a warning module, and a mail service module. The order-parsing module is for calculating requirements of each material based on the forecasted requirements and on Bills of Materials. The stock analysis module is for calculating a maximum stock and a minimum stock of each material based on the calculated requirements of the material and on standard stock rules, determining whether a current stock of the material falls between the maximum stock and the minimum stock, and thereby creating a stock analysis result. The warning module is for creating warnings based on stock analysis results. The mail service module is for sending e-mail warnings to relevant users.

In another aspect of the present invention, a stock-warning method comprises: (a) receiving forecasted requirements from one or more customers and storing the forecasted requirements in a database; (b) calculating requirements of individual materials according to the forecasted requirements; (c) calculating a maximum stock and a minimum stock of each material, determining whether a current stock of the material falls between the maximum stock and the minimum stock, and thereby creating an analysis result; (d) creating warnings based on the analysis results; and (e) accessing the database for e-mail addresses of relevant users, and sending e-mail warnings to the relevant users.

These and other objects and features of the present invention will become more fully apparent from the following description and appended claims, or may be learned by the practice of the invention as set forth hereinafter.

### BRIEF DESCRIPTION OF THE DRAWINGS

FIG. 1 shows hardware architecture of a stock-warning system in accordance with a preferred embodiment of the present invention;

FIG. 2 is a data source flow chart of the stock-warning system of FIG. 1;

FIG. 3 is a flow chart of operation of the system of FIG. 1;

FIG. 4 is a schematic illustration of a warning report displayed on one client computer of the system of FIG. 1, showing current stocks of various materials; and

FIG. 5 a schematic illustration of inventory information displayed on the client computer when a current stock of any one material displayed in FIG. 4 is clicked.

### DETAILED DESCRIPTION OF THE PREFERRED EMBODIMENT

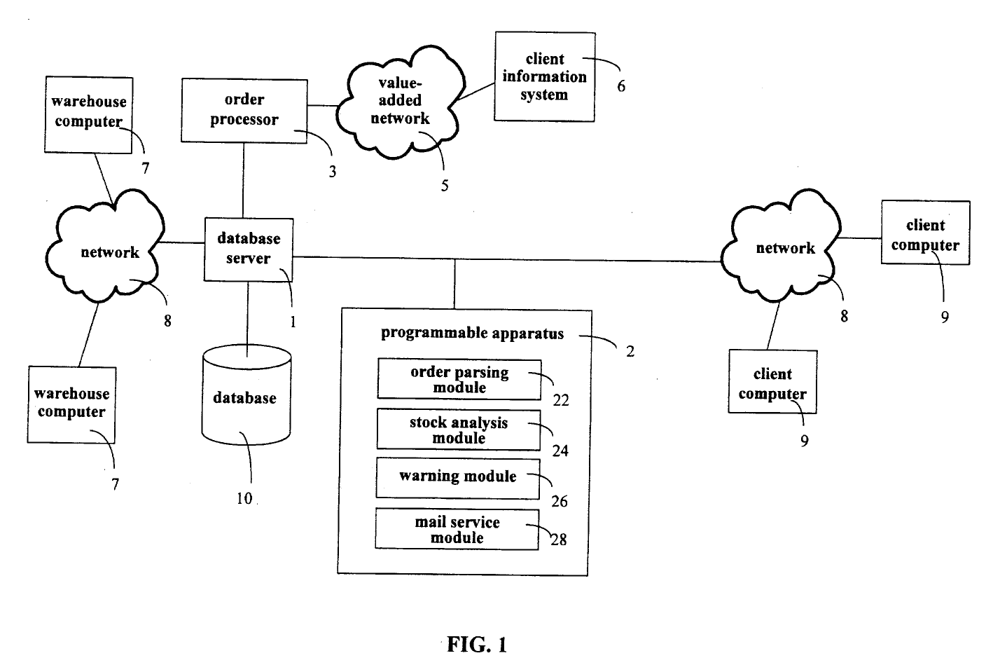

FIG. 1 shows hardware architecture of a stock-warning system in accordance with a preferred embodiment of the present invention. The system comprises a database server 1, a programmable apparatus 2, an order processor 3, a plurality of warehouse computers 7, and a plurality of client computers 9. The warehouse computers 7 are located at different sites. The order processor 3 is interconnected with one or more client information systems 6 through a value-added network 5. A customer sends forecasted requirements (FRs) through a client information system 6 to the order processor 3. The order processor 3 is used for converting the received FRs from an original format into another predetermined format. The original format may be a general format, such as EDI format, used in information intercommunication among different enterprises. The predetermined format may be a format that can be recognized by a relational database.

The database server 1 is used for receiving, processing and storing information of the system. The database server 1 comprises a database 10 for storing information. The database server 1 is connected to the order processor 3, receives converted FR information therefrom, and stores the converted FR information in the database 10. The database server 1 is interconnected with each of the warehouse computers 7 through a network 8. The database server 1 periodically receives current inventory information from each of the warehouse computers 7, and stores the inventory information in the database 10. The database 10 stores information on Bills of Materials (BOM), information on material requirements, standard stock rules, and information on e-mail addresses. The BOM information includes all kinds of materials needed by enterprises. The information on material requirements includes daily requirements of each of key materials. Various kinds of key materials are predetermined by enterprise users according to standard rules, such as the rule of ABC Classification. The standard stock rules define rules for calculating a standard stock of each key material. The information on e-mail addresses includes all e-mail addresses of relevant users, such users including warehouse managers and production managers.

The programmable apparatus 2 is used for calculating a standard stock of each of the key materials, and for determining whether a current stock exceeds the standard stock. If a current stock exceeds the standard stock, an abnormal current stock warning is generated, and the warning is sent to relevant users. The programmable apparatus 2 comprises an order-parsing module 22, a stock analysis module 24, a warning module 26, and a mail service module 28. The order-parsing module 22 is used for calculating requirements of each key material according to FRs. The stock analysis module 24 is used for calculating a standard stock of each key material, and for determining whether a current stock exceeds the standard stock to thereby create a stock analysis result. The warning module 26 is used for creating warnings according to the stock analysis result. The mail service module 28 is used for sending warnings to relevant users based on Simple Mail Transfer Protocol (SMTP).

Each of the client computers 9 is connected with the programmable apparatus 2 through the network 8. Each relevant user, including any applicable warehouse manager and production manager, receives e-mail warnings from the mail service module 28 through a respective client computer 9. The network 8 is a general electronic communications network, such as an intranet or the Internet. In the preferred embodiment of the present invention, the system is based on a browser/server B/S model. Users can access information in the database 10 through a web browser such as Microsoft Internet Explorer or Netscape Navigator.

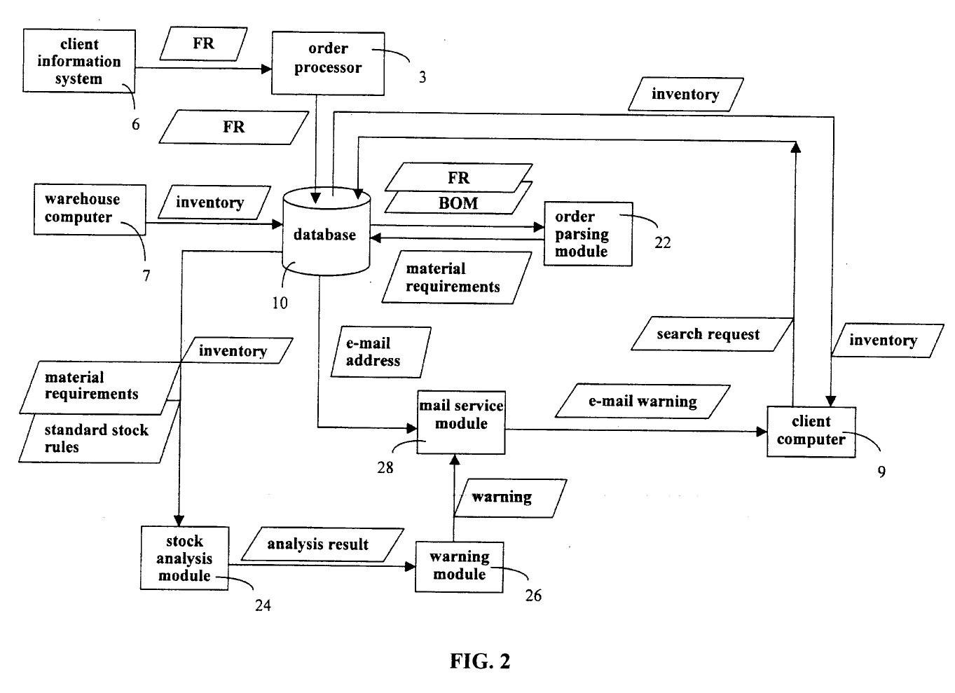

FIG. 2 is a data source flow chart of the system of the present invention. The order processor 3 receives FR information from the client information system 6, converts the FR information into another format which can be recognized by a relational database, and sends the converted FR information to the database server 1 for storing. The database server 1 periodically accesses each of the warehouse computers 7 to retrieve current inventory information. A time interval between each occasion of accessing is predetermined by users. The time interval may, for example, be one hour. The retrieved inventory information is stored in the database 10. The order-parsing module 22 accesses the database 10 for FR and BOM, calculates requirements of each material according to the FR and BOM, and stores the material requirements in the database 10. The stock analysis module 24 accesses the database 10 for inventory information, material requirements and standard stock rules. According to all this information, the stock analysis module 24 calculates a standard stock of each key material, determines whether a current stock exceeds the standard stock, and thereby creates a stock analysis result. The stock analysis result comprises information including client name, site, name of material, current stock, standard stock, and abnormality rate. The abnormality rate is determined by comparing the current stock with the standard stock. The standard stock comprises a maximum stock and a minimum stock. If current stock exceeds the maximum stock, the abnormality rate is calculated as follows:

abnormality rate=(current stock−maximum stock)/maximum stock.

If current stock falls below the minimum stock, the abnormality rate is calculated as follows:

abnormality rate=(minimum stock−current stock)/minimum stock.

If current stock falls between the maximum stock and the mimimum stock, the abnormality rate is zero. The stock analysis result is transmitted to the warning module 26. According to the stock analysis result, the warning module 26 may generate a warning, and transmit the warning to the mail service module 28. The mail service module 28 then accesses the database 10 for an e-mail address of each relevant user, and sends an e-mail warning to each relevant user. Each relevant user receives the e-mail warning through a respective client computer 9. In the preferred embodiment of the present invention, the e-mail warning comprises basic information and links leading to more detailed information. If a user clicks one of such links for more detailed information, the client computer 9 sends a search request to the database 10 for more detailed inventory information.

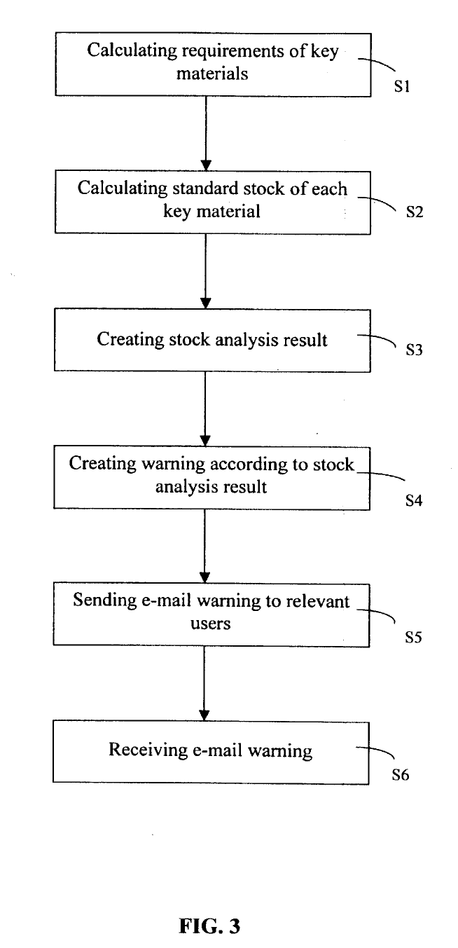

FIG. 3 is a flow chart of operation of the system of FIG. 1. Firstly, in step S1, the order-parsing module 22 accesses the database 10 for BOM information and FR information, parses the FR information into pieces of information respectively corresponding with each material of the BOM, and calculates requirements of each key material. In step S2, the inventory analysis module 24 calculates a maximum stock and a minimum stock of each material based on the standard stock rules. In step S3, the analysis module 24 accesses the database 10 for current stock information, compares the current stock with the standard stock, and thereby creates a stock analysis result. In step S4, the warning module 26 reads each piece of information of the stock analysis result, creates a warning based on information where any abnormality rate does not equal zero, and sends the warning to the mail service module 28. In step S5, the mail service module 28 accesses the database 10 for an e-mail address of each relevant user, and sends an e-mail warning to each relevant user. Finally, in step S6, each relevant user receives the e-mail warning through a respective client computer 9.

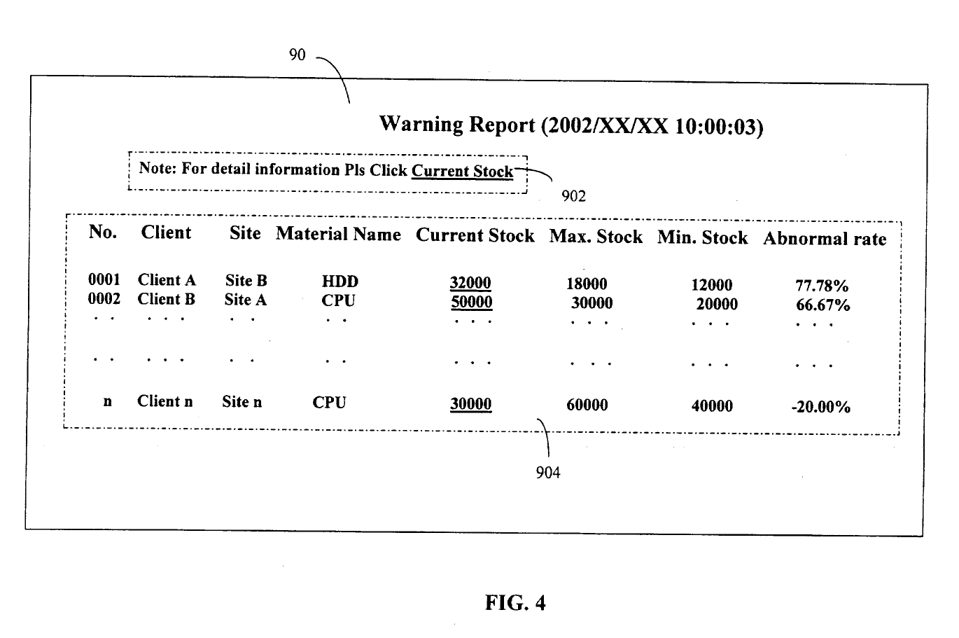

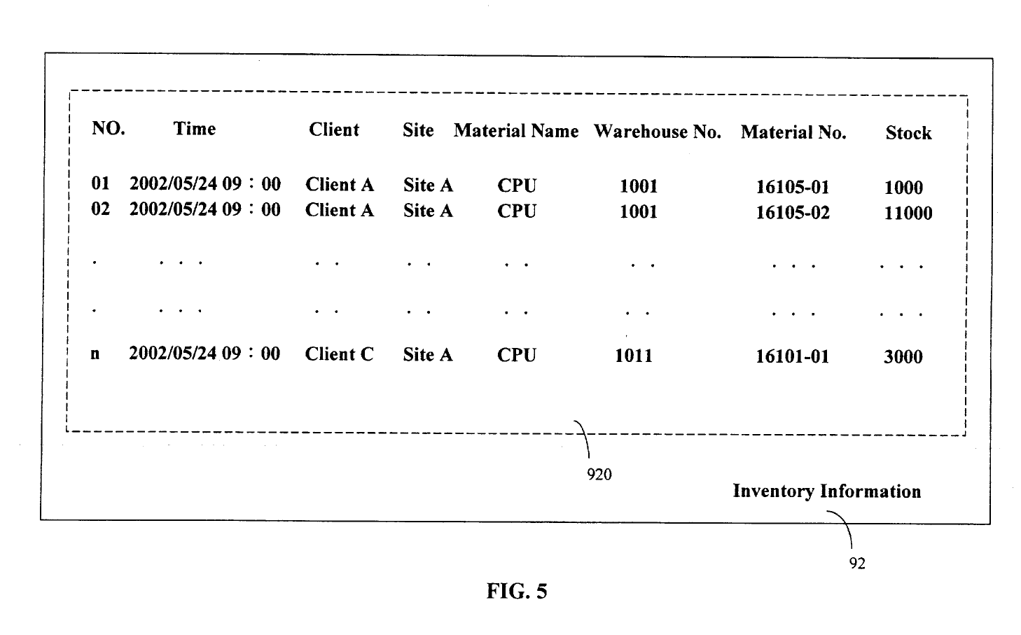

FIG. 4 is a schematic illustration of a warning report 90 displayed on one client computer 9. The warning report 90 includes a note 902 and a warning table 904. The note 902 indicates one or more links leading to more detailed information, such as a link to information on current stock of each material. The warning table 904 lists all materials whose abnormality rate does not equal zero. A user can click current stock of any one material to obtain more detailed inventory information on the selected material. FIG. 5 is a schematic illustration of inventory information 92 displayed on the client computer 9 when a current stock of any one material in FIG. 4 is clicked. The inventory information 92 includes an inventory table 920 showing full details regarding the selected material.

The embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

What is claimed is:

1. A stock-warning system comprising:
an order processor for receiving and processing forecasted requirements from at least one customer;
a database server for receiving and accessing the forecasted requirements, the database server comprising a database for storing the forecasted requirements, e-mail addresses and bills of materials; and
a programmable apparatus comprising:
an order-parsing module for calculating requirements of individual materials based on the forecasted requirements and the bills of materials;
a stock analysis module for calculating a maximum stock and a minimum stock of each material based on one or more requirements of the material, determining whether a current stock of the material falls between the maximum stock and the minimum stock, and creating an analysis result;
a warning module for creating warnings based on analysis results; and
a mail service module for sending e-mail warnings to relevant users.

2. The stock-warning system as claimed in claim 1, wherein the order processor converts the forecasted requirements from an original format into another predetermined format that can be recognized by a relational database.

3. The stock-warning system as claimed in claim 2, wherein the original format is electronic data interchange format.

4. The stock-warning system as claimed in claim 1, further comprising at least one warehouse computer located at at least one site, wherein the at least one warehouse computer stores current inventory information on each material.

5. The stock-warning system as claimed in claim 4, wherein the database server is interconnected with the at least one warehouse computer through an electronic communications network and periodically accesses the at least one warehouse computer to obtain current inventory information.

6. The stock-warning system as claimed in claim 1, wherein the requirements of individual materials indicate a daily requirement of each material.

7. The stock-warning system as claimed in claim 1, wherein the database is further for storing standard stock rules defining rules for calculating the maximum stock and minimum stock of each material.

8. The stock-warning system as claimed in claim 7, wherein the stock analysis module is for calculating a maximum stock and a minimum stock of each material based further on the standard stock rules.

9. The stock-warning system as claimed in claim 1, wherein the analysis result includes an abnormal rate of each material determined by comparing the current stock of the material with the maximum stock and the minimum stock of the material.

10. The stock-warning system as claimed in claim 1, further comprising a plurality of client computers for receiving the e-mail warnings.

11. A stock-warning method, the method comprising:
providing an order processor for receiving and processing forecasted requirements from at least one customer;
providing a database server for receiving and accessing the forecasted requirements, the database server comprising a database for storing the forecasted requirements, e-mail addresses and bills of materials; and
providing a programmable apparatus comprising:
an order-parsing module for calculating requirements of individual materials based on the forecasted requirements and the bills of materials;
a stock analysis module for calculating a maximum stock and a minimum stock of each material based on one or more requirements of the material, determining whether a current stock of the material falls between the maximum stock and the minimum stock, and creating an analysis result;
a warning module for creating warnings based on analysis results; and
a mail service module for sending e-mail warnings to relevant users.

12. The stock-warning method as claimed in claim 11, further comprising the step of providing at least one warehouse computer located at at least one site for accessing current inventory information.

13. The stock-warning method as claimed in claim 11, further comprising the step of providing a plurality of client computers for receiving the e-mail warnings.

14. A stock-warning method, the method comprising:
(a) receiving at least one forecasted requirement from at least one customer and storing the at least one forecasted requirement in a database;
(b) calculating a requirement of a material according to the at least one forecasted requirement;
(c) calculating at least a minimum stock of the material, determining whether a current stock of the material is beyond the minimum stock, and creating an analysis result;
(d) creating a warning based on the analysis result; and
(e) accessing the database for an e-mail address of a relevant user, and sending an e-mail warning to the relevant user.

15. The stock-warning method as claimed in claim 14, wherein step (a) further comprises converting the at least one forecasted requirement from an original format into a predetermined format which can be recognized by a relational database.

16. The stock-warning method as claimed in claim 14, further comprising the step of periodically accessing at least one warehouse computer located at at least one site to obtain current inventory information of the material.

17. The stock-warning method as claimed in claim 14, in step (c), further including calculating a maximum stock and determining whether said the current stock is below said maximum stock.

18. The stock-warning method as claimed in claim 17, wherein in step (c), the calculation of a maximum stock and a minimum stock of the material is based on standard stock rules.

19. The stock-warning method as claimed in claim 14, further comprising the step of receiving the e-mail warning through a client computer.
